(19) United States
(12) Patent Application Publication
(10) Pub. No.: US 2006/0108814 A1
(43) Pub. Date: May 25, 2006

(54) Bouncer

(76) Inventor: James T. Dunn, Hampton, NH (US)

Correspondence Address: JAMES DUNN, 27 SEAVIEW AVE, HAMPTON, NH, 03842, US

(21) Appl. No.: 10/992,410

(22) Filed: Nov. 19, 2004

(51) Int. Cl. B60R 19/42

(52) U.S. Cl. 293/128

(57) ABSTRACT

An inexpensive, easy to use, devise aimed to protect the doors of a parked vehicle. The apparatus consists of a padded foam tube with a nylon strap running through the center. It attaches quickly and easily to the vehicles wheels by running each end of the nylon straps through the vehicle's spoked wheels and is secured with quick-release adjustable buckles, leaving a padded zone of protection down the side of the parked vehicle.

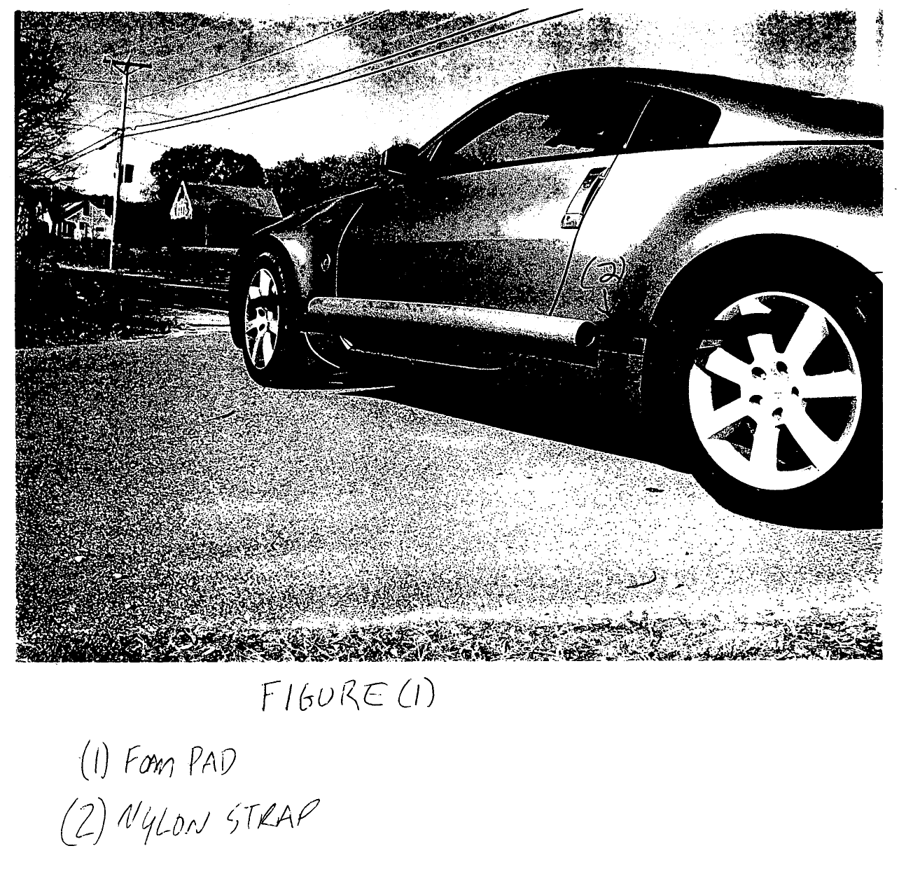

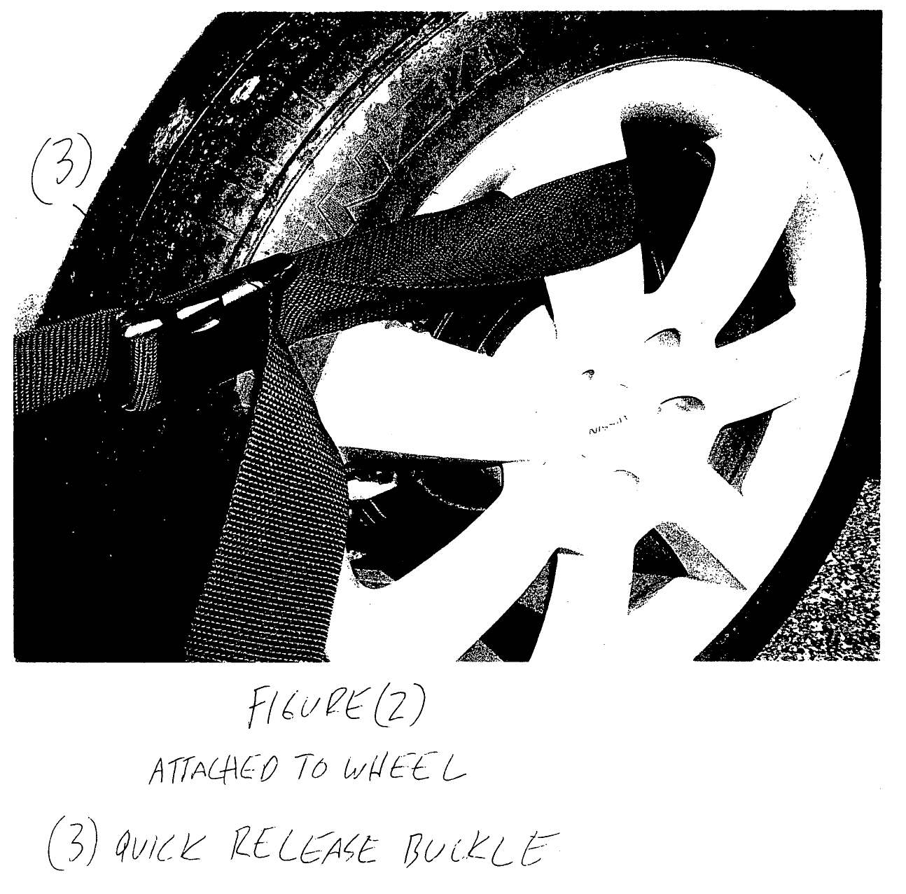

A thick, hollow foam tube with a nylon strap running through the center, that attaches to both the front and rear wheels of a vehicle, using quick release plastic buckles, providing protection against the opening doors of other vehicles.

### CROSS REFERENCE TO RELATED APPLICATIONS

U.S. Pat. No. 5,312,145 MacNeil
U.S. Pat. No. 4,493,502 Campbell
U.S. Pat. No. 6,179,354 Bennett

### BACKGROUND OF INVENTION

1. Field of Invention

This invention is designed to prevent damage done to parked vehicles by other vehicles' doors

2. Description of Prior Art

There have been other devises aimed at similar vehicle protection. The uniqueness of this invention design is that it is secured to the vehicle at the wheels. This is achieved by running the strap through the spokes of the vehicle's rims and attaching back onto the strap with a quick release buckle. This makes installation and removal of the apparatus quick and easy. It also avoids using hooks and magnets that are found in other devises, which can scratch the paint surface of the vehicle.

In researching other patent designs and investigating the automotive market, I found that my invention is the only design that attaches directly to the vehicles wheels, the most sturdy place on the vehicle. This design insures a horizontal line of protection covering the length of the vehicles doors. It also avoids using magnets (as in design in U.S. Pat. No. 5,312,145 to Robert MacNeil) which provide limited reliability and risk scratches. It avoids using hooks and stretched elastic cords (U.S. Pat. No. 4,493,502 to Campbell) which pose serious risk of scratches and gouges. It avoids complicated and timely set-up (as in U.S. Pat. No. 6,179,354 to Bennett). Vehicle owners who would purchase a device to protect their car are very reluctant to use these devises that could risk damage when a hook or cord or metal rod lets go. The simplicity of my design is it's beauty.

### BRIEF SUMMARY OF INVENTION

A simple, easy-to-use, inexpensive solution to the damage caused by other car's doors to your parked vehicle.

### DETAILED DESCRIPTION OF INVENTION

The devise is made up of three elements.
(1) A six foot long, eight inch diameter, hollow foam tube.
(2) a 20 foot long, 2 inch wide nylon strap
(3) quick release snap buckles, similar to those used on backpacks

The strap is attached to the vehicles wheels by running it through the spoked wheel and snapping the buckle back onto the strap. Then the other side is attached to the other wheel, and the strap is pulled tight. The result is a nylon strap going the entire length of the vehicle, with a foam pad in the center.

### Objects and Advantages

Objects and advantages of my described invention are:
(A) Prevents dings and scratches
(B) Quick and easy installation
(C) Simple to use
(D) fits almost any vehicle with spoked rims—adjusts easily
(E) Stores easily
(F) Inexpensive

### DRAWING FIGURES

FIG. (1) shows the invention attached to the side of a vehicle

FIG. (2) shows a close-up of how the invention attaches to the vehicles wheel

### REFERENCE NUMERALS

(1) Foam pad
(2) Nylon strap
(3) Quick release, adjustable buckles

I claim:

1. A vehicle door and body protector comprising of
A 2″ wide nylon strap;
encased in a 6′ long, thick foam tube;
with quick release, adjustable plastic buckles for easy installation and
removal to the vehicles wheels,
providing a horizontal foam tube of protection along the side of the vehicle.
